(19) United States
(12) Patent Application Publication
(10) Pub. No.: US 2004/0092697 A1
(43) Pub. Date: May 13, 2004

(54) Gel coat composition

(76) Inventors: Sheila F. Kia, Bloomfield Hills, MI (US); Devi N. Rai, Rochester Hills, MI (US); Hamid G. Kia, Bloomfield Hills, MI (US); Archie W. Garner, Ham Lake, MN (US); Ehtisham A. Ashai, Minneapolis, MN (US); Brian A. Robertson, Long Sault (CA); Thomas J. Melnyk, Greenfield, MN (US)

Correspondence Address: General Motors Corporation, Kathyrn A. Marra, Legal Staff, Mail Code 482-C23-B21, P.O. Box 300, Detroit, MI, 48265-3000, US

(21) Appl. No.: 10/624,039

(22) Filed: Jul. 21, 2003

Related U.S. Application Data
(60) Provisional application No. 60/402,472, filed on Aug. 9, 2002.
(60) Provisional application No. 60/402,657, filed on Aug. 12, 2002.
(60) Provisional application No. 60/431,811, filed on Dec. 9, 2002.
(60) Provisional application No. 60/402,793, filed on Aug. 12, 2002.

(51) Int. Cl. C08G 18/10; C08G 18/30

(52) U.S. Cl. 528/59; 528/60; 528/65; 528/84

(57) ABSTRACT

A gel coat for a surface of a composite article contains a curable urethane acrylate resin preferably based on aliphatic polyester polyols and aliphatic polyisocyanates. The gel coat provides a surface that has high gloss and color retention after prolonged exposure to ultraviolet radiation. The gel coat composition contains resin and acrylic diluents, including optional difunctional and trifunctional diluents. The gel coat is optionally pigmented to produce an article that may be used without further surface treatment.

### CROSS REFERENCE TO RELATED APPLICATIONS

This application claims the benefit of U.S. provisional patent applications 60/402,472 filed Aug. 9, 2002, 60/402,657 filed Aug. 12, 2002, 60/431,811 filed Dec. 9, 2002, and 60/402,793 filed Aug. 12, 2002.

### FIELD OF THE INVENTION

The present invention generally relates to gel coat finish layers.

### BACKGROUND OF THE INVENTION

Light-weight composites are commonly used in manufacturing many items.

To obtain a reasonable surface appearance, a gel coat is used over a supporting substrate. Parts can be produced to have a finish bearing any desired color originally carried by the gel coat. However, attainment of a gel coat surface with a suitably smooth finish remains a challenge.

It is desirable to produce a pigmented gel coat, so as to eliminate the need of painting, and to provide good protection against fading due to heat and ultraviolet radiation. A particular challenge is to produce a surface finish on the gel coat that is both defect free and highly resistant to degradation from exposure to ultraviolet radiation.

Therefore, it is desirable to improve the surface appearance of the gel coat, and provide a part that will maintain color and high gloss when exposed to the elements.

### SUMMARY OF THE INVENTION

In one aspect, the invention provides a gel coat suitable as a finish for a composite article. The gel coat layer contains a urethane acrylate resin, and in a preferred embodiment is pigmented. In a preferred embodiment, the gel coat further comprises an ultraviolet inhibitor package and viscosity control agents to control sag and surface appearance. A gel coat composition can be produced that on curing yields a surface having a good surface finish and gloss retention of more than 60% when exposed to UV radiation of 4500 kJ/m². The gel coat preferably provides a suitable surface finish to a supporting substrate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a two layer composite comprising a gel coat of the invention on a supporting substrate.

### DETAILED DESCRIPTION OF THE PREFERRED EMBODIMENTS

The following description of the preferred embodiment(s) is merely exemplary in nature and is in no way intended to limit the invention, its application, or uses.

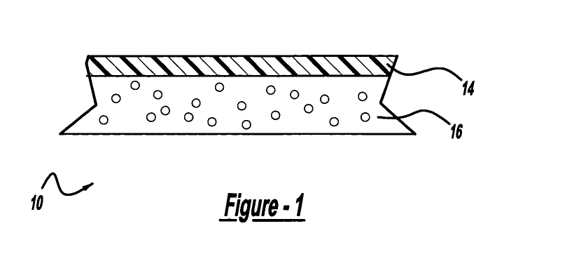

FIG. 1 shows in schematic form a composite 10 with a gel coat layer 14 of the invention. Two layers are shown: a substrate layer 16 and gel coat 14. The substrate provides most of the strength of the composite article. The gel coat layer may be pigmented. It is used to provide an aesthetic appearance to the composite article.

Composite articles comprising the gel coat of the invention are prepared by conventional processes. For example, a gel coat composition may be spread across the surface of a mold by any one of a number of conventional techniques, e.g., brushing, hand lay-up, or spraying, and usually as a relatively thick layer, e.g., 0.5 to 0.8 mm, to maximize its weather and wear resistance, and if the molded article is fiber-reinforced, to help mask the fiber reinforcement pattern which can show through the gel coat due to inherent resin shrinkage that occurs around the fibers during cure. After the gel coat is applied to the surface of the mold, it is at least partially cured. A plastic, optionally fiber-reinforced, then is applied to the partially or fully cured gel coat by any one of a number of conventional techniques, and the resulting laminate structure containing gel coat and substrate cured. Advantageously, the gel coat cures on the substrate at a temperature of 50° C. or less. The cure can be promoted through the use of free radical polymerization processes.

Gel coats of the invention are based on a class of urethane acrylate resins. The main ingredients of the gel coats are resin, pigment paste, diluents, additives, and initiator, each of which will be further discussed below. In a preferred embodiment, the gel coats of the invention retain a gloss of 60-70% and the colors stays consistent in the whole range of ultraviolet exposure of 500-4,500 kJ/m² in the Xenon accelerated weathering test. For example, the gel coats of the invention can obtain a DE rating of 3 or less in the Xenon test at 4,500 kJ/m².

The gel coat compositions typically contain from 30-60% of resin, preferably 30-50% and more preferably 35-45% resin, based on the total weight of the composition. The gel coat composition may contain pigment. When present, the pigment is typically present as a pigment paste, wherein the pigment paste is in the range of about 5-30% by weight of the total composition. In preferred embodiments, the pigment paste is present at from 10-30% by weight, and more preferably 10-25% by weight. Diluents are present in the gel coat composition at a range of about 10% to about 50% by weight of the composition, preferably from about 20% to about 40%. Additives make up the remainder of the composition. Such additives include, without limitation, dispersing agents, defoamers, ultraviolet light stabilizers, thixotropic agents, and the like. In addition, the compositions include up to 3% by weight of an initiator capable of initiating free radical polymerization of the monomers and the resins to cure the resin at a temperature of about 50° C. or less.

In one aspect, the resin of the gel coat is based on a urethane acrylate resin containing a polyurethane polymer with olefin functionality at the ends of the polymer. Preferred resins contain urethanes, or polyurethanes, end capped with acrylic based monomers, especially urethanes based on a polyester polyol intermediate. In a preferred embodiment, the resin of the gel coat is a reaction product of (a) an oligoester of weight average molecular weight (M_{w}) about 200 to about 4000, (b) a diisocyanate, and (c) a hydroxyalkyl (meth)acrylate.

A urethane-acrylate gel coat resin of the present invention has an idealized structure (I)

C-B-A-B-C, (I)

wherein (I) is the reaction product of an oligoester having M_{w} of about 200 to about 4,000 (A), a diisocyanate (B), and a hydroxyalkyl (meth)acrylate (C). A urethane acrylate gel coat resin of the present invention is a reaction product of A, B, and C, thus other reactions species generally are present in addition to a resin of idealized structure (I).

In accordance with an important feature of the present invention, a present urethane acrylate gel coat resin contains an oligoester of M_{w} about 200 to about 4000 that is reacted with a diisocyanate, and the resulting urethane product is end-capped with a hydroxyalkyl (meth)acrylate. The urethane acrylate resin therefore contains terminal vinyl groups available for free radical polymerization, typically using a peroxide catalyst.

The individual ingredients used in the manufacture of a present urethane acrylate gel coat resin are described in more detail below.

(a) Oligoester

The oligoester component (A) of a present urethane acrylate gel coat resin preferably has a weight average molecular weight of about 200 to about 4000 and preferably is prepared from one or more saturated polyol and one or more saturated or unsaturated polycarboxylic acid or dicarboxylic acid anhydride. As used herein, the terms “polyol” and “polycarboxylic” are defined as compounds that contain two or more, and typically two to four, hydroxy (OH) groups, or two or more, typically two or three, carboxyl (COOH) groups, respectively. Preferably, the oligoester is hydroxy terminated to provide reactive moieties for a subsequent reaction with a diisocyanate.

The polyesters typically are prepared from an aliphatic dicarboxylic acid or aliphatic dicarboxylic acid anhydride, and an aliphatic polyol. These ingredients are interacted preferably to provide a polyester having M_{w} of about 200 to about 4000, more preferably about 400 to about 3500, and most preferably about 500 to about 3000. Accordingly, the polyesters are low molecular weight oligoesters.

The oligoester typically is prepared, for example, by condensing an aliphatic dicarboxylic acid or aliphatic dicarboxylic acid anhydride with a polyol, preferably a diol. The polyol and dicarboxylic acid or acid anhydride, in correct proportions, are interacted under standard esterification procedures to provide an oligoester having the necessary M_{w}, molecular weight distribution, branching, and hydroxy-terminated functionality for use in a present urethane acrylate gel coat resin. In particular, the relative amounts of dicarboxylic acid and polyol are selected such that a sufficient excess molar amount of the polyol is present in order to provide a hydroxy terminated oligoester.

Non-limiting examples of diols used to prepare the oligoesters include ethylene glycol, diethylene glycol, trimethylene glycol, propylene glycol, dipropylene glycol, hexylene glycol, 1,3-butylene glycol, 1,4-butylene glycol, neopentyl glycol, cyclohexanedimethanol, pinacol, pentanediol, 2,2-dimethyl-1,3-propanediol, isopropylidene bis(p-phenyleneoxypropanol-2), a polyethylene or polypropylene glycol having a weight average molecular weight of about 500 or less, and mixtures thereof. A small amount of a triol or polyol, e.g., up to 5 mole %, more preferably 0 to 3 mole % of a triol or polyol, can be used to provide a partially branched, as opposed to linear, oligoester. Non-limiting examples of a triol include glycerol and trimethylolpropane.

Exemplary dicarboxylic acids, and anhydrides thereof, used to prepare a hydroxy-terminated oligoester include aliphatic dicarboxylic acids, such as, but not limited to, adipic acid, malonic acid, cyclohexanedicarboxylic acid, sebacic acid, azeleic acid, succinic acid, glutaric acid, and mixtures thereof. Substituted aliphatic dicarboxylic acids, such as halogen or alkyl-substituted dicarboxylic acids, also are useful.

Additional suitable dicarboxylic acids, and anhydrides thereof, include maleic, dihydroxymaleic, diglycollic, oxalacetic, oxalic, pimelic, suberic, chlorosuccinic, mesoxalic, acetone dicarboxylic, dimethyl malonic, 1,2-cyclopropanedicarboxylic, cyclobutane-1,1-dicarboxylic, cyclobutane-1,2-dicarboxylic, cyclobutane-1,3-dicarboxylic, cyclopentane-1,1-dicarboxylic, cyclopentane-1,2-dicarboxylic, 2,5-dimethylcyclopentane-1,1-dicarboxylic, alpha, alpha′-di-sec-butyl-glutaric, beta-methyl-adipic, isopropyl-succinic, and 1,1-dimethyl-succinic acids.

(b) Diisocyanate

The diisocyanate component (B) of a present urethane acrylate gel coat resin is an aliphatic diisocyanate. The diisocyanate component optionally can contain up to about 20%, and preferably up to about 10%, by total weight of the diisocyanate, of an aromatic diisocyanate. The identity of the aliphatic diisocyanate is not limited, and any commercially available commercial or synthetic diisocyanate can be used in the manufacture of a urethane acrylate gel coat resin of the present invention.

Non-limiting examples of aliphatic diisocyanates include 1,6-hexamethylene diisocyanate, isophorone diisocyanate, 1,4-cyclohexane diisocyanate, 2,4′-dicyclohexylmethane diisocyanate, 4,4′-dicyclohexylmethane diisocyanate, 1,3-bis-(isocyanatomethyl)cyclohexane, 1,4-bis(isocyanatomethyl)cyclohexane, tetramethylxylylene diisocyanate, 1,11-diisocyanatoundecane, 1,12-diisocyanatododecane, 2,2,4-trimethyl-1,6-diisocyanatohexane, 2,4,4-trimethyl-1,6-diisocyanatohexane, 1,2-bis(isocyanatomethyl)cyclobutane, hexahydro-2,4-diisocyanatotoluene, hexhydro-2,6-diisocyanatotoluene, 1-isocyanato-2-isocyanatomethyl cyclopentane, 1-isocyanato-3-isocyanatomethyl-3,5,5-trimethyl cyclohexane, 1-isocyanato-4-isocyanatomethyl-1-methyl cyclohexane, 1-isocyanato-3-isocyanatomethyl-1-methyl cyclohexane, and mixtures thereof. A preferred aliphatic diisocyanate is isophorone diisocyanate.

Non-limiting examples of optional aromatic diisocyanates includes toluene 2,4-diisocyanate, toluene 2,6-diisocyanate, 4,4′-methylene diphenyl diisocyanate, 2,4′-methylene diphenyl diisocyanate, polymeric methylene diphenyl diisocyanate, p-phenylene diisocyanate, naphthalene-1,5-diisocyanate, and mixtures thereof.

(c) Hydroxyalkyl (Meth)acrylate)

The hydroxyalkyl (meth)acrylate component (C) of a present urethane acrylate gel coat resin is preferably a hydroxyalkyl ester of an α,β-unsaturated acid, or anhydride thereof. Suitable α,β-unsaturated acids include a monocarboxylic acid such as, but not limited to, acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, cinnamic acid, p-chlorocinnamic acid, β-stearylacrylc acid, and mixtures thereof. As used throughout this specification, the term “(meth)acrylate” is an abbreviation for acrylate and/or methacrylate.

A preferred acrylate monomer containing a hydroxy group is a hydroxyalkyl (meth)acrylate having the following structure:

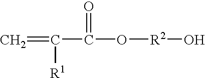

wherein R¹ is hydrogen or methyl, and R² is a C₁ to C₆ alkylene group or an arylene group. For example, R² can be, but is not limited to (—CH₂—)ₙ, wherein n is 1 to 6,

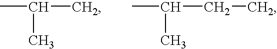

any other structural isomer of an alkylene group containing three to six carbon atoms, or can be a cyclic C₃-C₆ alkylene group. R² also can be an arylene group like phenylene (i.e., C₆H₄) or naphthylene (i.e., C₁₀H₆). R² optionally can be substituted with relatively non-reactive substituents, like C₁-C₆ alkyl, halo (i.e., Cl, Br, F, and I), phenyl, alkoxy, and aryloxy (i.e., an OR² substituent).

Specific examples of monomers containing a hydroxy group are the hydroxy(C₁-C₆)alkyl (meth)acrylates, e.g., 2-hydroxyethyl methacrylate, 2-hydroxyethyl acrylate, 2-hydroxypropyl methacrylate, and 3-hydroxypropyl methacrylate.

The relative amounts of (a), (b), and (c) used in the manufacture of a urethane acrylate gel coat resin of the present invention are sufficient to provide a reaction product having an idealized structure (I). Accordingly, component (a) is used in a molar amount of about 0.75 to about 1.25, and preferably about 0.9 to 1.1 moles; component (b) is used in an amount of 1.5 to about 2.5, and preferably about 1.7 to about 2.2 moles; and component (c) is used in an amount of about 1.5 to about 2.5, and preferably about 1.7 to about 2.2 moles. To achieve the full advantage of the present invention, the mole ratio of (a):(b):(c) is 1:1.7-2:1.75-2.

A urethane acrylate gel coat resin of the present invention is manufactured by first preparing the oligoester. The oligoester is prepared from a polyol, predominantly or completely a diol, and a polycarboxylic acid, predominantly or completely a dicarboxylic acid or anhydride thereof, using standard esterifying condensation conditions. The amounts and relative amounts of polyol and polycarboxylic acid are selected, and reaction conditions are used, such that the oligoester preferably has an M_{w} of about 200 to about 4000 and is hydroxy terminated. The oligoester can be saturated or unsaturated.

The oligoester then is blended with the hydroxyalkyl (meth)acrylate, followed by addition of the diisocyanate. The resulting reaction leads to a mixture of products, including a species having the idealized structure (I). Structure (I) has terminal acrylate moieties available for polymerization using standard free radical techniques, e.g., using initiators such as peroxides or peroxy esters.

The resin further contains diluent monomers. The diluent monomers are preferably selected from the group consisting of alkyl esters or hydroxyalkyl esters of acrylic acid or methacrylic acid. Examples include, without limitation, methyl methacrylate and 2-(hydroxyethyl)methacrylate.

In a preferred embodiment, the gel coat composition contains a pigment composition. The pigment composition is generally present in the form of a pigment paste. The paste contains a major amount of a saturated or unsaturated polyester as a carrier resin. The paste further contains minor amounts of wetting and dispersing agents and inhibitors. Generally, the pigment paste may be up to about 30% of the weight of the gel coat composition. In a preferred embodiment, the pigment paste is about 17 to 20% by weight of the gel coat composition. Of that, the saturated polyester or unsaturated polyester makes up about 16 to 18% by weight. The pigment is present up to about 0.3% by weight. The wetting agent makes up to about 1 to 1.5% of the gel coat composition, and inhibitors in the pigment paste make up about 0.1 to 0.2% of the gel coat composition. The pigment paste of the invention may be made by adding pigment and additives to the polyester resin and mixing in a grinding machine.

The gel coat composition further contains diluents in addition to those found in the resin. Typically, the diluents are present at about 10 to 50% by weight of the total composition, preferably about 20-40% by weight. Preferably, the diluents include at least one alkyl acrylate or alkyl methacrylate monomer. A preferred diluent is methyl methacrylate. Optionally the diluents may further comprise a hydroxyl containing acrylate or methacrylate ester as described above in the description of the resin. Other monomers may be added to enhance the cure profile. Such monomers include, without limitation, styrene, vinyl toluene, α-methylstyrene, divinylbenzene, diallyl phthalate, triallyl cyanurate, and the like. A preferred monomer is styrene.

The gel coat composition may optionally contain difunctional or trifunctional acrylic ester diluents. Such di- and trifunctional acrylic esters are well known in the art and may be prepared for example by reacting acrylic acid or methacrylic acid with a variety of monomeric diols and triols, or with ethoxylated or propoxylated diols and triols. When present, the di- and trifunctional acrylic esters provide an amount of crosslinking on cure suitable for obtaining desirable film properties in the cured gel coat. As a general matter, a certain amount of crosslinking is desired to improve the strength and durability of the coating containing the crosslinked resin. On the other hand, crosslinking tends to increase the hardness and brittleness of the coating. Preferably, di- and trifunctional diluents are added to the gel coat compositions in amounts sufficient to improve the durability of the coatings without causing excessive rigidity or brittleness that could lead to cracking. The di- and trifunctional acrylate and methacrylate esters are present in the gel coat compositions at from 0 to about 30% by weight. In a preferred embodiment, they are present at from about 5% to 20% by weight. In a preferred embodiment, a mixture of difunctional crosslinker and trifunctional crosslinker is used.

In another preferred embodiment, at least one of the difunctional and trifunctional acrylic ester diluents is an acrylic ester of an alkoxylated diol or triol. Alkoxylated diols and triols are produced by reacting a diol or triol with an alkylene oxide or mixture of alkylene oxides. Preferred alkylene oxides include ethylene oxide and propylene oxide. Alkoxylated diols have preferably 2 to 20 moles of oxide added per mole of diol. Alkoxylated triols have preferably 3 to 30 moles of oxide added per mole of triol. In one embodiment, an alkoxylated triol acrylic ester diluent is provided, having 3 to 30, preferably 3 to 15, and more preferably 3 to 9 moles of alkylene oxide per mole of triol. In a preferred embodiment, the alkoxylated triol has 3 to 9 moles of propylene oxide.

Examples of difunctional acrylic esters include, without limitation, triethylene glycol dimethacrylate, ethylene glycol dimethacrylate, tetraethylene glycol dimethacrylate, polyethylene glycol dimethacrylate, 1,3-butanediol diacrylate, 1,4-butanediol diacrylate, 1,4-butanediol dimethacrylate, diethylene glycol diacrylate, diethylene glycol dimethacrylate, 1,6-hexanediol diacrylate, 1,6-hexanediol dimethacrylate, neopentyl glycol diacrylate, neopentyl glycol dimethacrylate, tetraethylene glycol diacrylate, triethylene glycol diacrylate, 1,3-butylene glycol dimethacrylate, tripropylene glycol diacrylate, polyethylene glycol (400) diacrylate, polyethylene glycol (400) dimethacrylate, polyethylene glycol (600) diacrylate, propoxylated neopentyl glycol diacrylate, and alkoxylated aliphatic diol diacrylates.

Examples of trifunctional acrylic esters include, without limitation, tris-(2-hydroxyethyl) isocyanurate trimethacrylate, trimethylolpropane trimethacrylate, trimethylolpropane triacrylate, tris-(2-hydroxyethyl)isocyanurate triacrylate, tris-(2-hydroxyethyl)isocyanurate triacrylate, ethoxylated trimethylolpropane triacrylate, pentaerythritol triacrylate, propoxylated trimethylolpropane triacrylate, and propoxylated glycerol triacrylate.

Other additives make up the rest of the gel coat composition. Preferably, the gel coat compositions contain from 0.1 to 10% by weight, preferably from 0.2 to 5% by weight of additives that function as ultraviolet or light stabilizers. Light stabilizers for plastics and resin coatings are well known in the art and include without limitation benzophenones, xanthones, benzotriazoles, and hindered amine light stabilizers. The light stabilizers are available from a variety of commercial suppliers, including Ciba-Geigy (under the Tinuvin® and Chimassorb® lines) and BASF (under the Uvinul® designation). A wide variety of substituted benzophenones and xanthones is also available commercially from Norquay Technology, Inc.

Non-limiting examples of benzophenones UV light stabilizers include:

2,2′,4,4′-Tetrahydroxybenzophenone;

2,2′-Dihydroxy-4,4′-dimethoxybenzophenone;

2,2′-Dihydroxy-4,4′-dimethoxy-5-sulfobenzophenone;

2,2′-Dihydroxy-4,4′-dimethoxybenzophenone-5,5′-disodium sulfonate;

2,2′-Dihydroxy-4-methoxybenzophenone;

2,4-Dihydroxybenzophenone;

2-Hydroxy-4-(2-hydroxy-3-methacryloxy) propoxybenzophenone;

2-Hydroxy-4-alkoxybenzophenones;

2-Hydroxy-4-Dodecyloxybenzophenone;

2-Hydroxy-4-methoxybenzophenone;

2-Hydroxy-4-methoxy-2′-carboxybenzophenone;

2-Hydroxy-4-methoxy-5-sulfobenzophenone trihydrate

2-Hydroxy-4-n-octyloxybenzophenone; and

2-Hydroxy-4-octadecyloxybenzophenone

Non-limiting examples of benzotriazole UV light stabilizers include:

2-(2′-Hydroxy-3′,5′-di-t-amylphenyl) benzotriazole;

2-(2′-Hydroxy-3′,5′-di-tert-butylphenyl) benzotriazole;

2-(2′-Hydroxy-3′,5′-di-tert-butylphenyl)-5-chlorobenzotriazole;

2-(2′-hydroxy-3′,5′-Di-tert-pentylphenyl) benzotriazole;

2-(2′-Hydroxy-3′-tert-butyl-5′-methylphenyl)-5-chlorobenzotriazole;

2-(2′Hydroxy-5′-methylphenyl) benzotriazole;

2-(2′-Hydroxy-5′-t-octylphenyl) benzotriazole;

2-(2′-Hydroxyphenyl) benzotriazole; and

2-[2′-Hydroxy-3′-(3,4,5,6-tetra-hydrophthalimide-methyl)-5′-methylphenyl]benzotriazole.

Another class of preferred light stabilizers for the gel coats of the invention is the hindered amine light stabilizers. They function not but ultraviolet absorption but by their ability to scavenge or decompose radicals and hydroperoxides formed during photodegradation of polymers, and to quench singlet oxygen. They are available in a wide range of molecular weights and structures. A common type of hindered amine light stabilizer is based on a 2,2,6,6-tetraalkyl substituted piperidine ring. A variety of, for example, tetramethyl piperidines is commercially available. Examples include without limitation, Uvinul 4049H, Uvinul 4050H and Tinuvin 123. The Tinuvin 123 contains a major part of bis-(1-octyloxy-2,2,6,-tetramethyl-4-piperidyl) sebacate as active ingredient.

In a preferred embodiment the gel coat compositions of the invention contain from 0.2 to 2% by weight of a benzotriazole or benzophenone light stabilizer and from about 0.2 to 2% by weight of a hindered amine light stabilizer.

The gel coat compositions also contain an initiator capable of initiating cure of the gel coat by a free radical polymerization mechanism at temperatures of about 50° C. or lower. Preferably, the initiator is capable of initiating cure at room temperature, or about 20-30° C. Generally, the initiator includes both an initiator compound and an activator or promoter. The initiator and activator work in combination to initiate cure at a desired processing temperature. Preferred initiators include various organic peroxides and peracids. Examples of initiators that initiate cure at a temperature of about 50° C. or less include, without limitation, benzoyl peroxide, methyl ethyl ketone hydroperoxide (MEKP), and cumene hydroperoxide. In a preferred embodiment, methyl ethyl ketone hydroperoxide is used in a level of about 1-3%. Activators such as cobalt octoate, cobalt 2-ethylhexanoate, and cobalt naphthenate are suitable for working with the methyl ethyl ketone hydrogen peroxide to initiate cure. Non-cobalt containing promoters such as dimethylacetoacetamide may also be used. In a preferred embodiment, the gel coat compositions contain up to 1% of a cobalt containing promoter and up to 1% of a non-cobalt containing promoter such as dimethylacetoacetamide.

To prepare the gel coat compositions, the additives may be added in sequence to the resin with stirring. Thereafter the pigment paste may be added. The mixture is mixed thoroughly, filtered and stored in a drum. The promoter, such as dimethylacetoacetamide or a cobalt compound may be added to the drum at this time, or may be added to the composition prior to use. Generally, the initiator is not mixed in with the gel coat composition for storage. Rather, because the initiator and promoter together initiate cure at room temperature or preferably 50° C. or less, the initiator is added just before use or is preferably mixed in line as the gel coat composition is being applied.

The viscosity of the gel coat composition is preferably adjusted to a final viscosity of 3,000 to 4,000 CPS measured at 20 RPM. The gel time is preferably from about 3-6 minutes, and the thixotrope index is preferably adjusted to be in the range of 5.5 to 6.5.

Thus, the invention provides a gel coat layer comprising a resin suitable for use in relatively low temperature curing processes.

The invention has been described above with respect to preferred embodiments. Further non-limiting examples are given in the examples that follow.

### EXAMPLES

The following abbreviations are used in the Examples:

| | |
|---|---|
| NPG | neopentyl glycol |
| MA | maleic anhydride |
| DBTDL | Dibutyl tin dilaurate |
| HEA | 2-hydroxyethyl acrylate |
| IPDI | isophorone diisocyanate |
| MMA | methyl methacrylate |
| THQ | toluhydroquinone |
| TMP | trimethylolpropane |
| HALS | hindered amine light stabilizer |
| BYK-A-555 | silicone defoamer, commercially available from |
| | BYK-Chemie USA, Inc. |
| AEROSIL 200 | fumed silica, commercially available from Degussa |
| | Corporation |
| SARTOMER SR- | highly propoxylated 5.5 glyceryl triacrylate, |
| 9021 | commercially available from Sartomer, Exton, PA |
| SARTOMER | ethylene glycol dimethacrylate, commercially |
| SR-206 | available from Sartomer, Exton, PA |
| DMAA | dimethyl acetoacetamide |
| TINUVIN 928 | 2-(2H-benzotriazol-2-yl)-6-(1-methyl-1-phenylethyl- |
| | 4-(1,1,3,3-tetramethylbutyl)phenol, commercially |
| | available from Ciba Specialty Chemicals Corporation |
| TINUVIN 123 | bis-(1-octyloxy-2,2,6-tetramethyl-4-piperidyl) |
| | sebacate, a commercially available HALS from Ciba |
| | Specialty Chemicals Corporation |

### Example 1

NPG (101.64 wt. parts), MA (60.59 wt. parts), and DBTDL (0.42 wt. parts) were added into a flask equipped with a packed column and agitator. The resulting mixture was heated to a maximum of 440° F. and reacted to an acid number of about 5-10 under a nitrogen atmosphere by removing water (11.14 wt. parts). To the resulting oligoester (151.65 wt. parts) was added 2,6-di-t-butyl-p-cresol (0.65 wt. parts) and HEA (75.71 wt. parts) at 200° F. IPDI (114.28 wt. parts) was added to the resulting mixture via an addition funnel to maintain the exothermic reaction temperature below 200° F. The reaction was maintained at 200° F. for one hour followed by the addition of MMA (107.69 wt. parts) as a solvent and THQ (0.03 wt. parts) as an inhibitor. The resulting product was 80%, by weight, urethane acrylate gel coat resin in 20%, by weight, MMA solvent.

### Example 2

The urethane acrylate gel coat resin of this example contains a saturated oligoester. As in Example 1, the oligoester is reacted with IPDI and HEA to produce a urethane polyester copolymer having acrylic unsaturation at the terminal positions. The resin of Example 2 is prepared in a manner essentially identical to Example 1.

| Ingredient | Moles | Wt. Parts |
|---|---|---|
| 1. 1,6-Hexanediol | 2.69 | 24.76 |
| 2. TMP | 0.07 | 0.68 |
| 3. Adipic acid | 2 | 22.66 |

Ingredients 1-3 were reacted under esterifying conditions to remove 5.78 wt. parts of water, and provide an oligoester (40.78 wt. parts) of equivalent weight 239.1. The following ingredients were added to the oligoester, and reacted to form a urethane acrylate gel coat resin of the present invention.

| Ingredient | Moles | Wt. Parts |
|---|---|---|
| 4. DBTDL | | 0.08 |
| 5. 2,6-di-t-butyl-p-cresol | | 0.13 |
| 6. HEA | 2.11 | 13.92 |
| 7. IPDI | 4 | 25.30 |
| 8. THQ | | 0.006 |
| 9. MMA | | 19.79 |

### Example 3

1,6-Hexanediol (94.8 wt. parts) and TMP (2.6 wt. parts) were added into a flask equipped with an agitator, and the mixture was melted. Next, adipic acid (86.8 wt. parts) was added, and the resulting mixture was heated to 440° F., under a nitrogen atmosphere. An esterification reaction was performed, at a maximum temperature of 460° F., until the acid number was less than 10, preferably less than 7. Water (21.1 wt. parts) was removed during the reaction. The resulting oligoester was cooled to 140° F. using a one part air sparge and 2 part nitrogen blanket. Next, DBTDL (0.31 wt. parts), 2.6-di-t-butyl-p-cresol (0.53 wt. parts), HEA (55.7 wt. parts), and IPDI (101.2 wt. parts) were added to the oligoester. The IPDI was added at a rate such that the exothermic reaction was maintained below 200° F. (e.g., over about 30-60 minutes). The reaction was continued for 2 to 3 hours, periodically testing for free isocyanate groups (% NCO). A % NCO of less than 0.3 is preferred. At the completion of the reaction, THQ (0.03 wt. parts) and MMA (79.2 wt. parts) were added slowly to the urethane acrylate gel coat resin at a temperature below 190° F. The resulting mixture was stirred at 140° F. for at least one hour. The resulting product contained 80% urethane acrylate gel coat resin and 20% MMA solvent.

The urethane acrylate gel coat resins of the present invention can be used in gel coat compositions. A resin of the present invention is the base resin of the gel coat composition, and can be formulated with other standard gel coat composition ingredients. The urethane acrylate gel coat resin can be cured by polymerization of the terminal acrylate groups using standard free radical techniques.

In particular, gel coat compositions can be formulated using the resins of this invention in the usual method. Gel coat compositions include pigments, extenders, promoters, catalysts, stabilizers, and the like as practiced in the art. Such gel compositions typically comprise about 25 to about 50 weight percent urethane acrylate gel coat resin, and about 10 to about 50 weight percent styrene or other vinyl monomer, said percentages being based on combined weights of resin and vinyl monomer. Other gel coat composition-ingredients include acrylic diluents (e.g., MMA), additives (e.g., silica, cobalt salts, silicone release agent, hydroxyalkyl (meth)acrylates, dimethyl acetoacetamide), a pigment paste, a free radical initiator (e.g., methyl ethyl ketone peroxide), UV stabilizers, thixotropes, and other resins (e.g., an isophthalic-NPG-maleic unsaturated polyester).

The preparation of a gel coat composition, and curing of a gel coat composition to provide a gel coat for an article of manufacture are generally disclosed in WO 94/07674 and U.S. Pat. No. 4,742,121.

Example 4
General Dark Color Gel Coat Formula

| | wt. % |
|---|---|
| Urethane acrylate gel coat resin | 38-50 |
| (80% in MMA) | |
| Styrene | 0-5 |
| Air release agent | .1-1 |
| Thixotrope | .5-3 |
| Reactive monomer | 20-35 |
| Cobalt | .1-.5 |
| Cobalt promoter | .2-.7 |
| UV inhibitor | .2-.5 |
| HALS | .2-1 |
| Glycol synergist | .1-1.5 |
| Pigment paste | 10-25 |

Fillers (e.g., mica, aluminum trihydrate, barium sulfate, and the like) are optional ingredients present at 0-15 wt. %. Blocked isocyanates are also optional ingredients present at 0-20 wt. %.

Examples of reactive monomers include, but are not limited to, methyl methacrylate (10-20 wt. %), ethylene glycol dimethacrylate, e.g., SARTOMER SR-206 (1-10 wt. %), highly propoxylated glyceryl triacrylate, e.g., SARTOMER SR-9021 (0-10 wt. %), and mixtures thereof.

The pigment paste contains a pigment in an unsaturated polyester carrier resin. The paste also contains wetting agents, dispersing agents, and inhibitors, in minor amounts. Saturated polyesters also can be used as the carrier resin. The carrier resin also can be different from a polyester, e.g., a urethane diacrylate, an acrylic silicone, or similar resin. The pigment paste is prepared by adding the pigment and other ingredients to the carrier resin, then mixing in a grinding machine.

Example 5
Blue Gelcoat Composition

| Ingredient | Weight (kg) |
|---|---|
| Urethane acrylate gel coat resin of Example 2 | 42 |
| Styrene monomer | 4 |
| BYK-A 555 | 1 |
| AEROSIL 200 | 2 |
| Grind to 6 on Hegmann gauge | |
| SARTOMER SR 9021 | 10 |
| SARTOMER SR-206 | 1 |
| Methyl methacrylate | 19 |
| Cobalt octoate (12%) in mineral spirits and dipropylene | 0.5 |
| glycol monomethyl ether | |
| DMAA | 0.1 (gram) |
| TINUVIN 928 | .5 |
| TINUVIN 123 | 1 |
| 2-hydroxyethyl methacrylate | 1 |
| Blend 10 minutes | |
| Blue tinter | 17 |
| White tinter | 1 |

Example 6
White Gelcoat Composition

| Ingredient | Weight (kg) |
|---|---|
| Urethane acrylate gel coat resin of Example 2 | 24.6149 |
| Styrene monomer | 4 |
| BYK-A 555 | 1 |
| AEROSIL 200 | .5 |
| Grind to 6 on Hegmann Gauge | |
| SARTOMER SR-9021 | 7 |
| SARTOMER SR-206 | 1 |
| Methyl methacrylate | 17.175 |
| Cobalt octoate (12%) in mineral spirits and dipropylene | .2 |
| glycol monomethyl ether | |
| DMAA | .1 gram |
| TINUVIN 928 | .5 |
| TINUVIN 123 | 1 |
| 2-Hydroxyethyl methacrylate | 1 |
| Blend 10 minutes | |
| Blue tinter | .01 |
| White tinter | 42 |

### Example 7

### Preparation of Gel Coat Compositions

The following components may be used to prepare the gel coat compositions of the invention. The numbers in the right-hand column are percent by weight based on the total weight of the composition. Typically, all of the ingredients except the initiator are combined into a gel coat composition. The initiator is added to the rest of the composition just before use.

| Description | Weight % |
|---|---|
| Polyester-Polyurethane Acrylate | 30-60 |
| Styrene Monomer | 0-10 |
| Solution of foam destroying polymers | 0-2 |
| Thixotropic agent | 0.5-2.5 |
| Trifunctional acrylic ester | 0-20 |
| Difunctional acrylic ester | 0-10 |
| (meth)acrylate monomer | 5.0-25 |
| Co-containing promotor | 0-1.0 |
| Non-cobalt promoter | 0-1.0 |
| Non-HALS light stabilizer | 0-5.0 |
| HALS | 0-5.0 |
| Hydroxyl functional (meth) acrylate monomer | 0-10 |
| Polyester polyol | 0-1.0 |
| Solution of polyhydroxy carboxylic acid amides | 0-2.0 |
| Solution of foam destroying polysiloxanes | 0-2.0 |
| Solution of polyether modified methyl-alkyl-polysiloxane | 0-2.0 |
| copolymer | |
| (color pigments dispersed in a carrier polyester paste) | 0-30 |
| Cure initiator | 1.0-3.0 |

### Example 8

### Gel Coat Composition

A gel coat composition is formulated with the following ingredients.

| Component | Description | Parts |
|---|---|---|
| Resin | Polyester-Polyurethane Acrylate Resin | 42.5 |
| Styrene Monomer | Styrene Monomer | 4.0 |
| BYK A 555 | Solution of foam destroying polymers | 1.0 |
| Aerosil 200 | Fumed silica | 1.0 |
| Trifunctional | Propoxylated (5.5) Glycerol Triacrylate | 10.1 |
| acrylate | | |
| Difunctional | Ethylene glycol dimethacrylate | 1.0 |
| Acrylate | | |
| MMA | Methyl methacrylate | 17.8 |
| Cobalt 12% | Cobalt Octoate (12%) | 0.5 |
| Eastman DMAA | Dimethyl acetoacetamide | 0.4 |
| Tinuvin 928 | 2-(2H-Benzotriazol-2-yl)-6-(1-methyl-1- | 0.5 |
| | phenylethyl-4-(1,1,3,3- | |
| | tetramethylbutyl)phenol | |
| Tinuvin 123 | bis-(1-octyloxy-2,2,6,-tetramethyl-4- | 1.0 |
| | piperidyl) sebacate | |
| HEMA | 2-(hydroxyethyl)methacrylate | 1.0 |
| PDGG: Adipic Acid | Poly[di(ethylene glycol)/glycerol-adipic | 0.2 |
| Polyol | acid] polyol | |
| BYK R605 | Solution of polyhydroxy carboxylic acid | 0.4 |
| | amides | |
| BYK 66N | Solution of foam destroying polysiloxanes | 0.2 |
| BYK A525 | Solution of polyether modified methyl- | 0.5 |
| | alkyl-polysiloxane copolymer | |
| Pigment paste | (blue pigments dispersed in a carrier | 18.2 |
| | polyester paste) | |
| MEKP | Butanox LPT by Akzo Nobel | 1.5 |

### Example 9

### Gel Coat Composition

A gel coat composition is formulated with the following ingredients.

| Component | Description | Parts |
|---|---|---|
| Resin | Polyester-Polyurethane Acrylate Resin | 38.5 |
| Styrene Monomer | Styrene Monomer | 7.0 |
| BYK A 555 | Solution of foam destroying polymers | 0.4 |
| Aerosil 200 | Fumed silica | 1.6 |
| Difunctional | SR 206: Ethylene glycol dimethyl acrylate | 5.5 |
| acrylate | | |
| MMA | Methyl methacrylate | 12.3 |
| Cobalt 12% | Cobalt Octoate (12%) | 0.8 |
| Eastman DMAA | Dimethyl acetoacetamide | 0.2 |
| Tinuvin 928 | 2-(2H-Benzotriazol-2-yl)-6-(1-methyl-1- | 3.3 |
| | phenylethyl)-4-(1,1,3,3,- | |
| | tetramethylbutyl)phenol | |
| Tinuvin 123 | bis-(1-octyloxy-2,2,6,-tetramethyl-4- | 0.2 |
| | piperidyl) sebacate | |
| HEMA | 2-Hydroxyethyl methacrylate | 3.3 |
| PDGG: Adipic Acid | Poly[di(ethylene glycol)/glycerol-adipic | 1.3 |
| Polyol | acid] polyol | |
| BYK R605 | Solution of polyhydroxy carboxylic acid | 0.4 |
| | amides | |
| BYK A525 | Solution of polyether modified methyl- | 0.4 |
| | alkyl-polysiloxane copolymer | |
| Pigment paste | (green pigments dispersed in a carrier | 25.3 |
| | polyester paste) | |
| MEKP | Butanox LPT by Akzo Nobel | 1.3 |

### Example 10

### Gel Coat Composition

A gel coat composition is formulated with the following ingredients.

| Component | Description | Parts |
|---|---|---|
| Resin | Polyester-Polyurethane Acrylate Resin | 35.5 |
| Styrene Monomer | Styrene Monomer | 9.5 |
| BYK A 555 | Solution of foam destroying polymers | 1.0 |
| Aerosil 200 | Fumed silica | 1.0 |
| Trifunctional | Propoxylated (5.5) Glycerol Triacrylate | 2.2 |
| acrylate | | |
| Difunctional | Ethylene glycol dimethacrylate | 8.9 |
| acrylate | | |
| MMA | Methyl methacrylate | 8.5 |
| Cobalt 12% | Cobalt Octoate (12%) | 0.5 |
| Eastman DMAA | Dimethyl acetoacetamide | 0.4 |
| Tinuvin 928 | 2-(2H-Benzotriazol-2-yl)-6-( 1-methyl-1- | 0.5 |
| | phenylethyl)-4-(1,1,3,3,- | |
| | tetramethylbutyl)phenol | |
| Tinuvin 123 | bis-(1-octyloxy-2,2,6,-tetramethyl-4- | 2.0 |
| | piperidyl) sebacate | |
| PDGG: Adipic Acid | Poly[di(ethylene glycol)/glycerol-adipic | 0.2 |
| Polyol | acid] polyol | |
| BYK 66N | Solution of foam destroying polysiloxanes | 0.2 |
| BYK A525 | Solution of polyether modified methyl- | 0.5 |
| | alkyl-polysiloxane copolymer | |
| Pigment paste | (white pigments dispersed in a carrier | 29.4 |
| | polyester paste) | |
| MEKP | Butanox LPT by Akzo Nobel | 1.5 |

### Example 11

### Exemplary use of the Gel Coat to Form a Finished Article

A gel coat composition according to Examples 1-10 is applied to a desired thickness and allowed to cure. Cure may be carried out at room temperature or up to about 50° C. Depending on the temperature, the cure time may range from several minutes to several hours to up to a day.

The description of the invention is merely exemplary in nature and, thus, variations that do not depart from the gist of the invention are intended to be within the scope of the invention. Such variations are not to be regarded as a departure from the spirit and scope of the invention, which are defined in the appended claims.

We claim:

1. A gel coat composition comprising a gel coat resin and at least one diluent monomer, wherein the gel coat resin comprises reaction products of a reaction mixture comprising
(a) a hydroxy-terminated oligoester having weight average molecular weight of about 200 to about 4000;
(b) a diisocyanate; and
(c) a hydroxyalkyl (meth)acrylate.

2. A composition according to claim 1, wherein the oligoester is saturated or unsaturated and has a weight average molecular weight of about 500 to about 3000.

3. A composition according to claim 1, wherein a reaction mixture of (a), (b), and (c) contains a molar ratio of about 0.75 to about 1.25 mole (a) to about 1.5 to about 2.5 moles (b) to about 1.5 to about 2.5 moles (c).

4. A composition according to claim 3, wherein a reaction mixture of (a), (b), and (c) contains a molar ratio of about 0.9 to about 1.1 mole (a) to about 1.7 to about 2.2 moles (b) to about 1.7 to about 2.2 moles (c).

5. A composition according to claim 4, wherein a reaction mixture of (a), (b), and (c) contains a molar ratio of about 0.95 to about 1.05 mole (a) to about 1.7 to about 2 moles (b) to about 1.7 to about 2 moles (c).

6. A composition according to claim 1, wherein the diisocyanate comprises an aliphatic diisocyanate and up to 20% of an aromatic diisocyanate, by total weight of the diisocyanate.

7. A composition according to claim 6, wherein the aliphatic diisocyanate comprises 1,6-hexamethylene diisocyanate, isophorone diisocyanate, 2,4′-dicyclohexylmethane diisocyanate, or 4,4′-dicyclohexylmethane diisocyanate.

8. A composition according to claim 1, wherein the hydroxyalkyl (methyl)acrylate has a structure 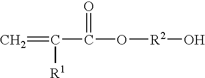
wherein R¹ is hydrogen or methyl and R² is a C₁ to C₆ alkylene group or an arylene group.

9. A composition according to claim 8, wherein the hydroxyalkyl (meth)acrylate comprises 2-hydroxyethyl methacrylate, 2-hydroxyethyl acrylate, 2-hydroxypropyl methacrylate, or 3-hydroxypropyl methacrylate.

10. A composition according to claim 1 wherein the oligoester comprises a reaction of product of (a) neopentyl glycol, 1,6-hexanediol, or a mixture thereof, and (b) adipic acid.

11. A composition according to claim 10, wherein the diisocyanate comprises isophorone diisocyanate.

12. A composition according to claim 11, wherein the hydroxyalkyl (meth)acrylate comprises 2-hydroxyethyl acrylate.

13. A gel coat composition according to claim 1, wherein the gel coat resin is present in the composition in an amount of about 25% to about 50%, by weight, of the composition.

14. A gel coat composition according to claim 1, further comprising a pigment.

15. A gel coat composition according to claim 1, wherein the diluent monomer comprises an acrylate monomer.

16. A gel coat composition according to claim 1, wherein the diluent monomer comprises a difunctional acrylate monomer.

17. A gel coat composition according to claim 1, wherein the diluent monomer comprises a trifunctional acrylate monomer.

18. A gel coat composition according to claim 1, wherein the diluent monomer comprises styrene, vinyl toluene, α-methylstyrene, divinylbenzene, diallyl phthalate, or triallyl cyanurate.

19. A gel coat composition according to claim 1, wherein the diluent monomer comprises ethylene glycol dimethacrylate.

20. A gel coat composition according to claim 1, wherein the diluent monomer comprises a triacrylate ester of propoxylated glycerol.

21. A cured gel coat prepared by curing a gel coat composition according to claim 1.

22. An article of manufacture having an exterior gel coat prepared by curing a gel coat composition according to claim 1.

23. A gel coat composition comprising a gel coat resin and at least one diluent monomer, wherein the gel coat resin is made by a process comprising the steps of
(a) preparing a hydroxy-terminated oligoester having a weight average molecular weight of about 200 to about 4000 by reacting (i) a saturated diol and optional saturated triol with (ii) a saturated or unsaturated dicarboxylic acid, a saturated or unsaturated dicarboxylic acid anhydride, or a mixture thereof, in sufficient relative amounts of (i) and (ii) to provide terminal hydroxy groups;
(b) adding a hydroxyalkyl (meth)acrylate to the oligoester of step (a) to form a prereaction mixture;
(c) then adding a diisocyanate to the prereaction mixture of step (b) to form a reaction mixture; and
(d) maintaining the reaction mixture of step (c) at a sufficient temperature for a sufficient time to react essentially all isocyanate moieties of the diisocyanate and yield the urethane acrylate gel coat resin.

24. A composition according to claim 23, wherein the gel coat resin is prepared using a molar ratio of (I) oligoester to (II) diisocyanate to (III) hydroxyalkyl (meth)acrylate of about 0.75 to about 1.25 (I) to about 1.5 to about 2.5 (II) to about 1.7 to about 2.5 (III).

25. A composition according to claim 24, wherein the gel coat resin is prepared using a mole ratio of about 0.9 to about 1.1 (I) to about 1.5 to about 2.2 (II) to about 1.5 to about 2.2 (III).

26. A composition according to claim 24, wherein the gel coat resin is prepared using a mole ratio of about 0.95 to about 1.05 (I) to about 1.7 to about 2 (II) to about 1.7 to about 2 (III).

27. A composition according to claim 23, wherein the diisocyanate comprises an aliphatic diisocyanate and up to 20% of an aromatic diisocyanate, by total weight of the diisocyanate.

28. A composition according to claim 27, wherein the diisocyanate comprises 1,6-hexamethylene diisocyanate, isophorone diisocyanate, 2,4′-dicyclohexylmethane diisocyanate, or 4,4′-dicyclohexylmethane diisocyanate.

29. A composition according to claim 23, wherein the oligoester comprises a reaction product of (a) neopentyl glycol, 1,6-hexanediol, or a mixture thereof, and (b) adipic acid.

30. A composition according to claim 29, wherein the diisocyanate comprises isophorone diisocyanate.

31. A composition according to claim 23, further comprising a pigment.
